(19) United States
(12) Patent Application Publication
(10) Pub. No.: US 2024/0355025 A1
(43) Pub. Date: Oct. 24, 2024

(54) INTER-ACCOUNT INTERACTION METHOD AND APPARATUS, COMPUTER DEVICE, AND STORAGE MEDIUM

(71) Applicant: Tencent Technology (Shenzhen) Company Limited, Shenzhen (CN)

(72) Inventors: Yingjie MEI, Shenzhen (CN); Meng WEI, Shenzhen (CN); Xianqi JING, Shenzhen (CN); Lili HAO, Shenzhen (CN); Xingyu XIAO, Shenzhen (CN); Hongjiang WANG, Shenzhen (CN); Ruowei JIANG, JIANG (CN); Jun ZHANG, Shenzhen (CN); Xiaogiang HONG, Shenzhen (CN); Lichao WU, Shenzhen (CN)

(21) Appl. No.: 18/761,158

(22) Filed: Jul. 1, 2024

Related U.S. Application Data
(63) Continuation of application No. PCT/CN2023/082558, filed on Mar. 20, 2023.

(30) Foreign Application Priority Data
May 23, 2022 (CN) 202210566922.3

(51) Int. Cl. G06T 13/00; A63F 13/30; A63F 13/53; G06F 3/04817

(52) U.S. Cl. CPC G06T 13/00; A63F 13/30; A63F 13/53; G06F 3/04817

(57) ABSTRACT

This application provides an inter-account interaction method performed by a computer device. The method includes: displaying a battle preparation interface of a virtual battle, the battle preparation interface comprising a first icon representing a first account associated with the computer device and at least one second icon representing an account other than the first account; in response to a trigger operation on one of the at least one second icon as a target icon, displaying a prop selection area on the battle preparation interface and at least one interactive prop owned by the first account in the prop selection area; and in response to a selection of one of the at least one interactive prop as a target interactive prop, playing a target special effect animation of transmitting a special effect resource of the target interactive prop pointing from the first icon to the target icon.

### CROSS-REFERENCE TO RELATED APPLICATIONS

This application is a continuation application of PCT Patent Application No. PCT/CN2023/082558, entitled “INTER-ACCOUNT INTERACTION METHOD AND APPARATUS, COMPUTER DEVICE, AND STORAGE MEDIUM” filed on Mar. 20, 2023, which claims priority to Chinese Patent Application No. 202210566922.3, entitled “INTER-ACCOUNT INTERACTION METHOD AND APPARATUS, COMPUTER DEVICE, AND STORAGE MEDIUM” filed on May 23, 2022, both of which are incorporated herein by reference in their entirety.

### FIELD OF THE TECHNOLOGY

This application relates to the technical field of computer technologies, and in particular, to an inter-account interaction method and apparatus, a computer device, and a storage medium.

### BACKGROUND OF THE DISCLOSURE

With the development of computer technologies, more and more types of games can be played. A multiplayer online battle arena (MOBA) game is a popular game. When playing this type of game, players may perform interaction by transmitting emoticons.

### SUMMARY

Embodiments of this application provide an inter-account interaction method and apparatus, a computer device, and a storage medium, which not only enriches an inter-account interaction manner, but also improves efficiency of human-computer interaction, and further improves efficiency of inter-account interaction. Technical solutions are as follows:

According to an aspect, an inter-account interaction method is performed by a computer device, the method including:
displaying a battle preparation interface of a virtual battle, the battle preparation interface comprising a first icon and at least one second icon, the first icon representing a first account associated with the computer device, the second icon representing an account other than the first account;
in response to a trigger operation on one of the at least one second icon as a target icon, displaying a prop selection area on the battle preparation interface and at least one interactive prop owned by the first account in the prop selection area; and
in response to a selection of one of the at least one interactive prop as a target interactive prop, playing a target special effect animation of transmitting a special effect resource of the target interactive prop pointing from the first icon to the target icon.

According to another aspect, a computer device is provided, the computer device including a processor and a memory, the memory being configured to store at least one computer program, the at least one computer program, when executed by the processor, causing the computer device to implement the inter-account interaction method in the embodiments of this application.

According to another aspect, a non-transitory computer-readable storage medium is provided, the computer-readable storage medium having at least one computer program stored therein, the at least one computer program, when executed by a processor of a computer device, causing the computer device to implement the inter-account interaction method in the embodiments of this application.

### BRIEF DESCRIPTION OF THE DRAWINGS

FIG. 1 is a schematic diagram of an implementation environment of an inter-account interaction method according to an embodiment of this application.

FIG. 2 is a flowchart of an inter-account interaction method according to an embodiment of this application.

FIG. 3 is a flowchart of another inter-account interaction method according to an embodiment of this application.

FIG. 4 is a schematic diagram of a battle preparation interface at a team forming stage according to an embodiment of this application.

FIG. 5 is a schematic diagram of a battle preparation interface at an object selection stage according to an embodiment of this application.

FIG. 6 is a schematic diagram of a battle preparation interface at a loading stage according to an embodiment of this application.

FIG. 7 is a flowchart of transmitting a prop use request according to an embodiment of this application.

FIG. 8 is a flowchart of playing a target special effect animation according to an embodiment of this application.

FIG. 9 is an interaction flowchart of an inter-account interaction method according to an embodiment of this application.

FIG. 10 is a flowchart of another inter-account interaction method according to an embodiment of this application.

FIG. 11 is a schematic structural diagram of an inter-account interaction apparatus according to an embodiment of this application.

FIG. 12 is a schematic structural diagram of another inter-account interaction apparatus according to an embodiment of this application.

FIG. 13 is a schematic structural diagram of a terminal according to an embodiment of this application.

FIG. 14 is a schematic structural diagram of a server according to an embodiment of this application.

### DESCRIPTION OF EMBODIMENTS

Information (including, but not limited to, user device information, user personal information, and the like), data (including, but not limited to, data configured for analysis, stored data, presented data, and the like), and a signal involved in this application are all authorized by a user or fully authorized by all parties, and collection, use, and processing of relevant data are required to comply with a relevant law, regulation, and standard of a relevant country and region. For example, both an interactive prop and a special effect resource of the interactive prop involved in this application are obtained under full authorization.

For ease of understanding, terms involved in this application are explained below.

MOBA game: It is a network game. In an MOBA game, players are generally divided into two teams. The two teams dispersedly compete with each other on a game map. Each player controls a virtual object of the player to perform many behaviors.

Team forming stage: It is a stage at which players in a game form teams. The team forming stage is a stage at which battle preparation is performed for a virtual battle.

Object selection stage: It is a stage at which a player in a game selects a virtual object. The object selection stage is a stage at which preparation is performed for a virtual battle.

Loading stage: It is a waiting stage of loading a virtual scene of a virtual battle after a player in a game selects a virtual object. The virtual scene includes the virtual object selected by the player.

Player avatar: It is an image of a player that is of a small square style and is used by the player in a game.

Bust image: It is an image of a rectangular style presented by a virtual object selected by a player at a loading stage of a game.

An inter-account interaction method provided in an embodiment of this application can be performed by a computer device. In some embodiments, the computer device is a terminal or a server. An implementation environment of the inter-account interaction method provided in this embodiment of this application is described below by using an example in which the computer device is a terminal. FIG. 1 is a schematic diagram of an implementation environment of an inter-account interaction method according to an embodiment of this application. Refer to FIG. 1. The implementation environment includes a terminal 101 and a server 102. The terminal 101 and the server 102 can be directly or indirectly connected in a wired or wireless communication manner. This is not limited in this application.

In some embodiments, the terminal 101 may be a smartphone, a tablet computer, a notebook computer, a desktop computer, a smart speaker, a smartwatch, a smart voice interaction device, a smart home appliance, an in-vehicle terminal, or the like, but is not limited thereto. The terminal 101 has an application installed and run thereon. The application supports a virtual battle. The application may be any one of a first-person shooting (FPS) game, a third-person shooting game, a multiplayer online battle arena (MOBA) game, and a multiplayer gunfight survival game. When preparing for the virtual battle, the terminal 101 may display a battle preparation interface of the virtual battle. A first icon and at least one second icon are displayed on the battle preparation interface. The first icon is configured for representing a first account logged in on the terminal 101, and the second icon is configured for representing another account logged in on another terminal 101. A player controls the terminal 101 to cause the first account to use an interactive prop on another account to perform interaction with another account. In this case, the terminal 101 can display a special effect resource of the interactive prop pointing from the first icon to a target icon. The target icon is configured for representing an account that performs interaction with the first account.

There may be more or fewer terminals. For example, there is one terminal, or there are dozens of or hundreds of terminals or more. A quantity of terminals and a device type of the terminal are not limited in the embodiments of this application.

In some embodiments, the server 102 may be an independent physical server, or may be a server cluster or a distributed system formed by a plurality of physical servers, or may be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data or an artificial intelligence platform. The server 102 is configured to provide a backend service for the application supporting the virtual battle. The backend service may be a data storage service, an information verification service, an information transmission service, or the like. This is not limited in the embodiments of this application.

For example, the server 102 is configured to provide the information verification service for the application supporting the virtual battle. When the terminal 101 on which the first account is logged in uses the interactive prop on another account, the terminal 101 on which the first account is logged in can transmit a prop use request to the server 102. The server 102 can perform verification on the prop use request. When the verification on the prop use request is passed, the terminal 101 and another terminal 101 can obtain the special effect resource corresponding to the interactive prop.

In some embodiments, the server 102 is responsible for primary computing work, and the terminal 101 is responsible for secondary computing work. Alternatively, the server 102 is responsible for secondary computing work, and the terminal 101 is responsible for primary computing work. Alternatively, a distributed computing architecture is used between the server 102 and the terminal 101 to perform collaborative computing.

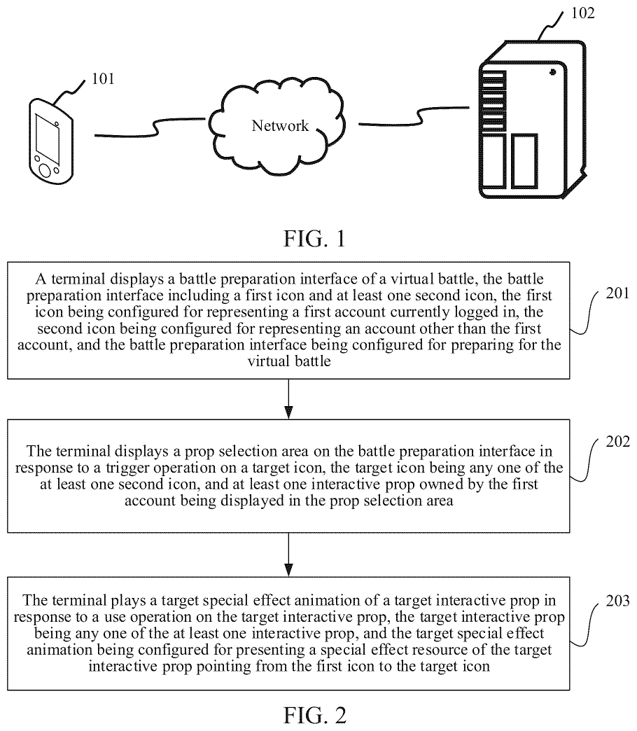

FIG. 2 is a flowchart of an inter-account interaction method according to an embodiment of this application. Refer to FIG. 2. Description is made by using execution by a terminal as an example in this embodiment of this application. The inter-account interaction method includes the following operations.

201: The terminal displays a battle preparation interface of a virtual battle, the battle preparation interface including a first icon and at least one second icon, the first icon being configured for representing a first account currently logged in, the second icon being configured for representing an account other than the first account, and the battle preparation interface being configured for preparing for the virtual battle.

In this embodiment of this application, the terminal is the terminal 101 shown in FIG. 1, and the terminal has an application installed thereon. The application supports the virtual battle. The virtual battle includes a preparation stage and a progress stage. At the preparation stage of the virtual battle, the terminal can prepare for the virtual battle. At the progress stage of the virtual battle, virtual objects of different camps confront each other in a virtual scene. When preparing for the virtual battle, the terminal displays the battle preparation interface of the virtual battle. The first icon and the at least one second icon are displayed on the battle preparation interface. The first icon is configured for representing the first account currently logged in on the terminal, and the second icon is configured for representing another account currently logged in on another terminal. Both the first account and another account are accounts that participate in the virtual battle. Each of the first icon and the second icon may be a player avatar, or may be a bust image of a virtual object selected by a player. This is not limited in the embodiments of this application. A quantity of the at least one second icon may be 1, 4, 9, or the like. This is not limited in the embodiments of this application.

202: The terminal displays a prop selection area on the battle preparation interface in response to a trigger operation on a target icon, the target icon being any one of the at least one second icon, and at least one interactive prop owned by the first account being displayed in the prop selection area.

In this embodiment of this application, the terminal displays the prop selection area on the battle preparation interface in response to the trigger operation on the any one of the at least one second icon. The trigger operation may be a tap operation, a double-tap operation, a long press operation, a drag operation, or the like. This is not limited in the embodiments of this application. A display location of the prop selection area may be near the target icon or near the first icon, or may be a preset location on the battle preparation interface. This is not limited in the embodiments of this application. The prop selection area includes the at least one interactive prop. A quantity of interactive props in the prop selection area is not limited in the embodiments of this application. The interactive prop may be a prop, such as a firework, a heart, or a flower, configured for interaction. This is not limited in the embodiments of this application.

203: The terminal plays a target special effect animation of a target interactive prop in response to a use operation on the target interactive prop, the target interactive prop being any one of the at least one interactive prop, and the target special effect animation being configured for presenting a special effect resource of the target interactive prop pointing from the first icon to the target icon.

In this embodiment of this application, there is a special effect resource corresponding to any interactive prop. The special effect resource is configured for synthesizing a special effect animation of the interactive prop. In other words, there is a special effect animation corresponding to any interactive prop. In response to the use operation on the any one of the at least one interactive prop, the terminal can play a special effect animation of the interactive prop. To be specific, when the first account uses the target interactive prop on an account represented by the target icon, the terminal can play the target special effect animation of the target interactive prop.

In the solution provided in this embodiment of this application, when preparing for the virtual battle, by triggering the target icon on the battle preparation interface, the prop selection area including the at least one interactive prop can be displayed on the battle preparation interface. By selecting the target interactive prop in the at least one interactive prop, the target special effect animation corresponding to the target interactive prop can be played, and that the first account uses the target interactive prop on another account can be intuitively displayed. In this way, interaction between the first account and another account is implemented. To be specific, interaction can be performed without using a chat channel. This not only enriches an interaction manner, but also improves efficiency of human-computer interaction, and further improves efficiency of inter-account interaction.

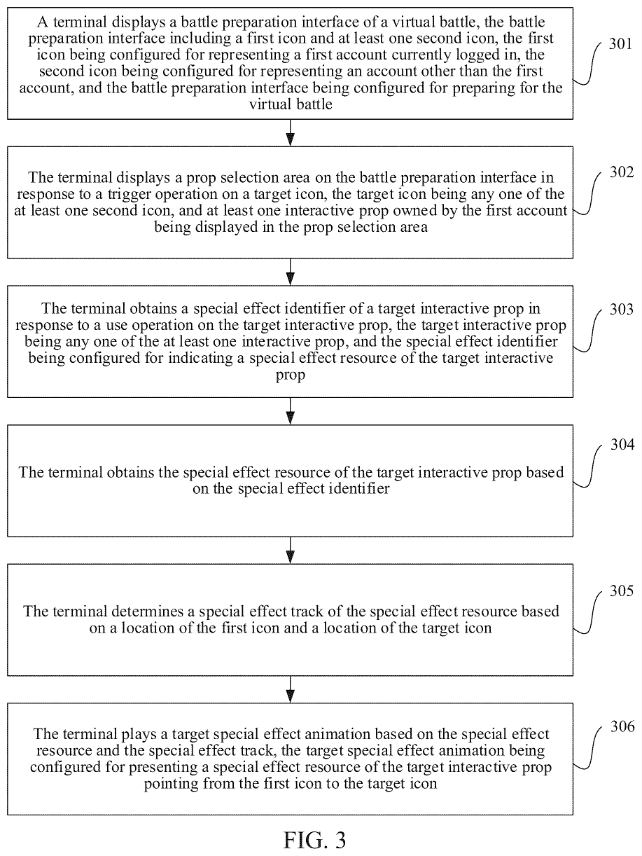

The target special effect animation in this embodiment of this application may be generated by the terminal or a server. The solution provided in this application is further described below by using an example in which the terminal generates the target special effect animation. FIG. 3 is a flowchart of another inter-account interaction method according to an embodiment of this application. Refer to FIG. 3. Description is made by using execution by a terminal as an example in this embodiment of this application. The inter-account interaction method includes the following operations.

301: The terminal displays a battle preparation interface of a virtual battle, the battle preparation interface including a first icon and at least one second icon, the first icon being configured for representing a first account currently logged in, the second icon being configured for representing an account other than the first account, and the battle preparation interface being configured for preparing for the virtual battle.

In this embodiment of this application, the terminal is the terminal 101 shown in FIG. 1. The terminal has an application supporting the virtual battle installed thereon. The virtual battle includes a preparation stage and a progress stage. At the preparation stage of the virtual battle, the terminal can prepare for the virtual battle. At the progress stage of the virtual battle, virtual objects of different camps confront each other in a virtual scene. Content prepared by the terminal at the preparation stage may be creating a camp team to participate in the virtual battle, selecting a virtual object to participate in the virtual battle, loading the virtual scene of the virtual battle, or the like. This is not limited in the embodiments of this application. When preparing for the virtual battle, the terminal can display a corresponding battle preparation interface based on the prepared content. A plurality of icons are displayed on the battle preparation interface. The plurality of icons may be player avatars, or may be bust images of virtual objects selected by players, or may be dynamic images of the virtual objects selected by the players, or may be three-dimensional models of the virtual objects selected by the players. This is not limited in the embodiments of this application. “A plurality of” means two or more. The plurality of icons include the first icon and the at least one second icon.

The terminal can perform at least one of the foregoing preparations for the virtual battle. Correspondingly, the preparation stage of the virtual battle may be a separate stage. For example, the preparation stage of the virtual battle is an object selection stage or a loading stage. In this case, the terminal performs one preparation for the virtual battle. The preparation stage of the virtual battle may alternatively be divided into a plurality of stages. For example, the preparation stage of the virtual battle includes a team forming stage, an object selection stage, and a loading stage. In this case, the terminal performs three preparations for the virtual battle.

The following uses an example in which the terminal performs a plurality of preparations for the virtual battle as an example for description. According to different prepared content, the preparation stage of the virtual battle is divided into three stages: the team forming stage, the object selection stage, and the loading stage. Because prepared content at different stages is different, battle preparation interfaces displayed by the terminal at the different stages are also different. Icons on the different battle preparation interfaces may be the same or may be different.

In some embodiments, at the team forming stage, the terminal can create the camp team to participate in the virtual battle. In this case, icons corresponding to accounts belonging to a same camp are displayed on the battle preparation interface. To be specific, the first account represented by the first icon and another account represented by the second icon belong to a same camp, and a player corresponding to the first account and a player corresponding to a second account are mutually teammates.

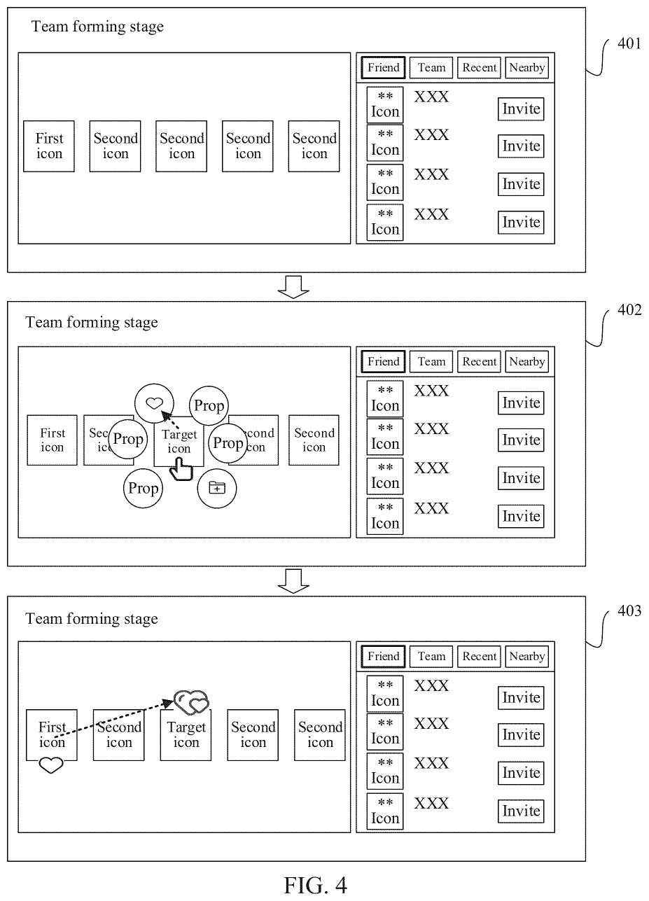

For example, FIG. 4 is a schematic diagram of a battle preparation interface at a team forming stage according to an embodiment of this application. Refer to FIG. 4. 401 in FIG. 4 exemplarily shows that a first icon and four second icons are displayed on the battle preparation interface. The first icon and the four second icons are all player avatars. A player corresponding to the first icon and players corresponding to the four second icons belong to a same camp. A friend list is further displayed on the battle preparation interface. The friend list includes a plurality of players in a friend relationship with the player corresponding to the first icon. The player corresponding to the first icon can invite players in the friend list to create a camp team.

In some embodiments, after creation of a camp team to participate in a virtual battle is completed, a terminal can match an enemy camp for the camp team. After the matching is successful, a player to participate in the virtual battle can select a virtual object to participate in the virtual battle. In other words, after the team forming stage ends, the terminal matches the enemy camp for the camp team, and then enters an object selection stage. At the object selection stage, each of players of a plurality of camps can select a virtual object to participate in the virtual battle. In this case, icons corresponding to accounts belonging to the plurality of camps are displayed on the battle preparation interface. To be specific, a first account represented by the first icon and another account represented by the second icon may belong to a same camp or may belong to different camps. The player corresponding to the first account and the player corresponding to the second account are mutually teammates or mutually opponents.

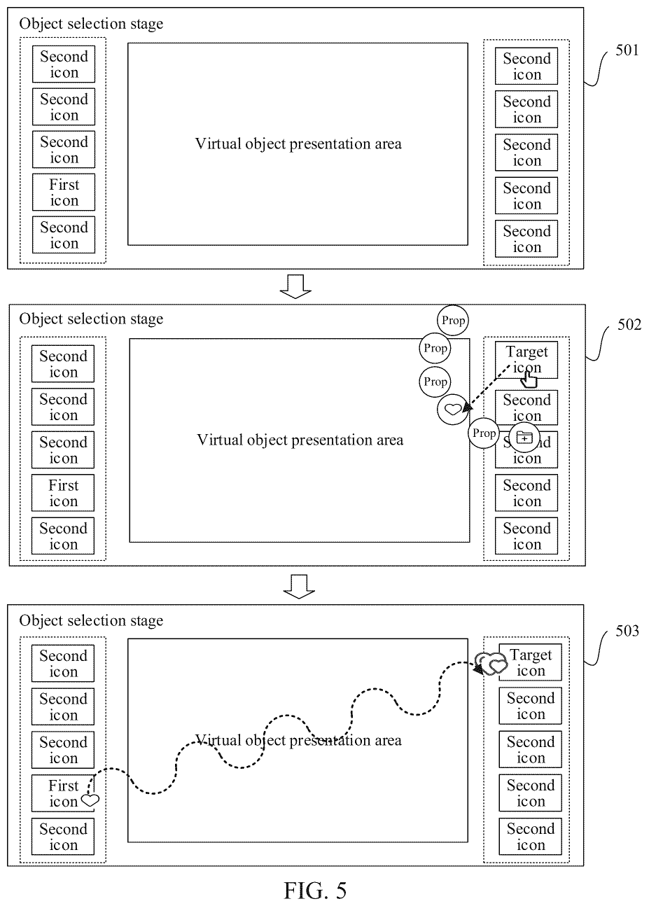

For example, FIG. 5 is a schematic diagram of a battle preparation interface at an object selection stage according to an embodiment of this application. Refer to FIG. 5. 501 in FIG. 5 exemplarily shows that a first icon and nine second icons are displayed on the battle preparation interface. The first icon and the nine second icons are all player avatars. Player avatars corresponding to players belonging to different camps are divided according to the camps, and are respectively displayed on a left side and a right side of the battle preparation interface. A virtual object presentation area is further displayed on the battle preparation interface. When a player selects a virtual object through a first account, the selected virtual object can be presented in the presentation area.

In some embodiments, at a loading stage, a player to participate in a virtual battle has selected the virtual object. In this case, the terminal can load a virtual scene of the virtual battle. The virtual scene includes the virtual object selected by the player. In this case, icons corresponding to accounts belonging to a plurality of camps are displayed on the battle preparation interface.

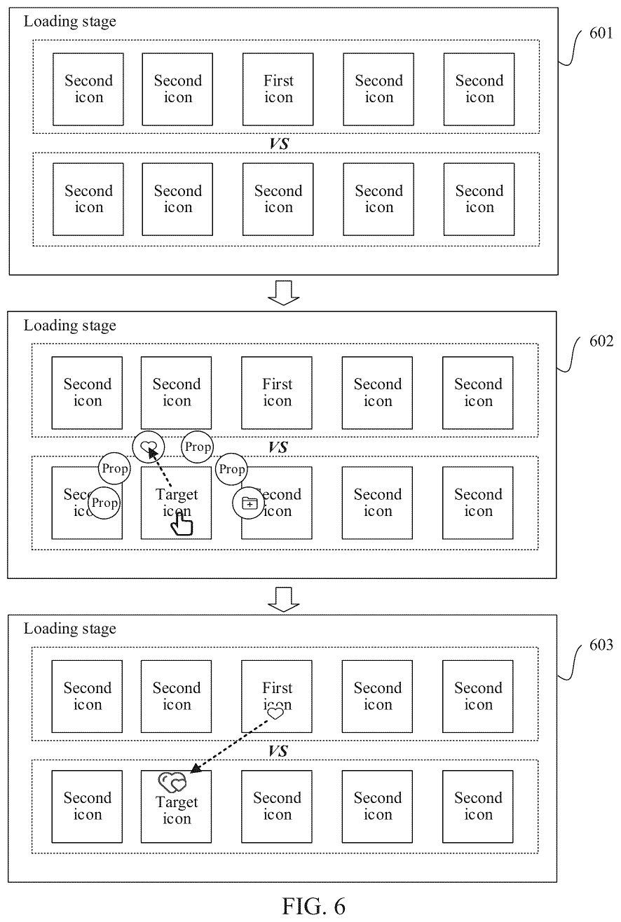

For example, FIG. 6 is a schematic diagram of a battle preparation interface at a loading stage according to an embodiment of this application. Refer to FIG. 6. 601 in FIG. 6 exemplarily shows that a first icon and nine second icons are displayed on the battle preparation interface. The first icon and the nine second icons are all bust images of virtual objects selected by players. Bust images corresponding to players belonging to different camps are divided according to the camps, and are respectively displayed on an upper side and a lower side of the battle preparation interface.

302: The terminal displays a prop selection area on the battle preparation interface in response to a trigger operation on a target icon, the target icon being any one of the at least one second icon, and at least one interactive prop owned by the first account being displayed in the prop selection area.

In this embodiment of this application, the target icon is any icon other than the first icon on the battle preparation interface. When the target icon is triggered, the terminal can display the prop selection area. At least one interactive prop is displayed in the prop selection area. A quantity and types of interactive props in the prop selection area are not limited in the embodiments of this application. Each of the at least one interactive prop is an interactive prop owned by the first account. The prop selection area is configured for selecting an interactive prop to be used by the first account on an account represented by the target icon. The prop selection area may be a circular area, a square area, or a polygonal area. This is not limited in the embodiments of this application. A display location of the prop selection area may be near the target icon or near the first icon, or may be a preset location on the battle preparation interface. This is not limited in the embodiments of this application.

In some embodiments, the prop selection area is a circular area, and a center of the prop selection area overlaps with a center of the target icon. The prop selection area may be considered as a wheel. Because display locations of icons on the battle preparation interface at different preparation stages are different, and are limited by a size of a screen of the terminal, the terminal can adjust a size or a display range of the prop selection area, so that all interactive props in the prop selection area can be displayed.

In a first case, the preparation stage is the team forming stage. For example, still refer to FIG. 4. 402 in FIG. 4 exemplarily shows a prop selection area. The prop selection area includes six subareas. The six subareas are all circular areas. Centers of the six subareas are at equal distances from the center of the target icon. In other words, the centers of the six subareas are all located on a circle with the center of the target icon as a center of the circle. Different subareas correspond to different types of interactive props. A prop is displayed in each of five subareas in the prop selection area, and a remaining subarea is empty. A prop pack is displayed in the empty subarea. The prop pack is configured to indicate a prop base of the first account. A plurality of interactive props of the first account are stored in the prop base. The terminal can add an interactive prop to the subarea in response to a trigger operation on the subarea.

In a second case, the preparation stage is the object selection stage. For example, still refer to FIG. 5. 502 in FIG. 5 exemplarily shows a prop selection area. The prop selection area includes six subareas. The six subareas are all circular areas. Centers of the six subareas are at equal distances from the center of the target icon. In other words, the centers of the six subareas are all located on an arc with the center of the target icon as a center of the arc. To display all interactive props in the prop selection area, the terminal can adjust the distance between the center of the subarea and the center of the target icon, to increase the distance between the center of the subarea and the center of the target icon. The distance between the center of the subarea and the center of the target icon at the object selection stage is farther than that at the team forming stage. Because the target icon is located at the upper right of the battle preparation interface, to display all interactive props in the prop selection area, the prop selection area is located at the lower left of the target icon.

In a third case, the preparation stage is the loading stage. For example, still refer to FIG. 6. 602 in FIG. 6 exemplarily shows a prop selection area. The prop selection area includes six subareas. The six subareas are all circular areas. Centers of the six subareas are at equal distances from the center of the target icon. In other words, the centers of the six subareas are all located on an arc with the center of the target icon as a center of the arc. To display all interactive props in the prop selection area, the terminal can adjust the distance between the center of the subarea and the center of the target icon, to increase the distance between the center of the subarea and the center of the target icon. The distance between the center of the subarea and the center of the target icon at the loading stage is farther than that at the team forming stage. Because the target icon is located at a lower part of the battle preparation interface, to display all interactive props in the prop selection area, the prop selection area is located above the center of the target icon.

The interactive prop in the prop selection area is not changeless. The terminal can display a different interactive prop in the prop selection area based on a consumption frequency of the interactive prop, a remaining quantity of interactive props, or an account relationship between accounts.

In some embodiments, the terminal can display the prop selection area based on the consumption frequency of the interactive prop. A higher consumption frequency of the interactive prop indicates a higher probability that the player corresponding to the first account reuses the interactive prop. A lower consumption frequency of the interactive prop indicates a lower probability that the player corresponding to the first account reuses the interactive prop. Correspondingly, a process in which the terminal displays the prop selection area is that the terminal obtains a consumption frequency of the at least one interactive prop in response to the trigger operation on the target icon; and then the terminal displays the prop selection area on the battle preparation interface based on the consumption frequency of the at least one interactive prop. The at least one interactive prop is displayed in the prop selection area in descending order of the consumption frequency. In the solution provided in this embodiment of this application, because there is a high probability that the player corresponding to the first account reuses the interactive prop with a high consumption frequency, the interactive props in the prop selection area are displayed in descending order of the consumption frequencies of the interactive props, so that the interactive prop with the high consumption frequency can be preferentially displayed, which facilitates subsequent use of the interactive prop with the high consumption frequency. This not only satisfies an intention of the player, but also improves efficiency of human-computer interaction.

In some embodiments, the terminal may display the prop selection area based on the remaining quantity of interactive props. Correspondingly, the process in which the terminal displays the prop selection area is that the terminal obtains a remaining quantity of the at least one interactive prop in response to the trigger operation on the target icon; and then the terminal displays the prop selection area on the battle preparation interface based on the remaining quantity of the at least one interactive prop. The at least one interactive prop is displayed in the prop selection area in descending order of the remaining quantity. In the solution provided in this embodiment of this application, the interactive props in the prop selection area are displayed in descending order of the remaining quantities of the interactive props, so that the interactive prop with a large remaining quantity can be preferentially displayed, which facilitates subsequent use of the interactive prop with the large remaining quantity, and avoids a case in which a specific interactive prop cannot be used because the interactive prop has been consumed, thereby improving efficiency of human-computer interaction.

In some embodiments, the terminal can display the prop selection area based on the account relationship between accounts. The account relationship may be at least one of no relationship, a teammate relationship, an opponent relationship, a couple relationship, and a friend relationship. This is not limited in the embodiments of this application. Different types of interactive props are used between accounts in different account relationships. For example, an interactive prop such as a heart or a firework may be used between accounts in the friend relationship, an interactive prop such as a kitchen knife or a hammer may be used between accounts in the opponent relationship, and an interactive prop such as a flower or a piece of candy may be used between accounts in no relationship. Correspondingly, the process in which the terminal displays the prop selection area is that the terminal obtains an account relationship between the first account and the second account in response to the trigger operation on the target icon; and then the terminal displays at least one interactive prop corresponding to the account relationship in the prop selection area of the battle preparation interface. The second account is an account represented by the target icon. In the solution provided in this embodiment of this application, the interactive prop in the prop selection area is displayed through the account relationship between accounts, so that an interactive prop more consistent with the intention of the player can be displayed. In this way, there is no need to select another interactive prop, thereby improving efficiency of human-computer interaction.

The interactive prop in the prop selection area may alternatively be set by the player corresponding to the first account through the terminal. Correspondingly, a process of setting the interactive prop in the prop selection area is that the terminal displays a prop adding interface; then the terminal displays a plurality of interactive props of the first account in response to a trigger operation on a prop adding control on the prop adding interface; and then the terminal determines, in response to a prop selection operation, the at least one interactive prop selected from the plurality of interactive props. The prop adding interface is configured for adding the interactive prop for the first account. In the solution provided in this embodiment of this application, the prop adding interface is displayed, so that the player can independently set the interactive prop in the prop selection area based on a requirement of the player. In this way, when the interactive prop is subsequently used, an interactive prop that satisfies the requirement can be directly found in the prop selection area. In this way, there is no need to select another interactive prop, thereby improving efficiency of human-computer interaction.

The terminal may further display the prop selection area by using a prop selection control. Correspondingly, the process in which the terminal displays the prop selection area is that the terminal displays the prop selection control in response to the trigger operation on the target icon; and then the terminal displays the prop selection area on the battle preparation interface in response to a trigger operation on the prop selection control. The prop selection control is configured to select an interactive prop to be used on the second account, and the second account is an account represented by the target icon. In addition, the prop selection control may be fixedly displayed at a specific location of the battle preparation interface. When the target icon is not triggered, the terminal can display the prop selection area by using the prop selection control. In the solution provided in this embodiment of this application, the prop selection area is displayed by using the prop selection control. In this way, an operation is simple, efficiency of human-computer interaction can be improved, and a case in which the prop selection area is displayed due to accidental touching of the icon when there is no need to use the interactive prop is avoided, thereby reducing running consumption.

303: The terminal obtains a special effect identifier of a target interactive prop in response to a use operation on the target interactive prop, the target interactive prop being any one of the at least one interactive prop, and the special effect identifier being configured for indicating a special effect resource of the target interactive prop.

In this embodiment of this application, there is a prop identifier for any interactive prop. Prop identifiers of different interactive props are different. There is a special effect resource corresponding to any interactive prop. There is a special effect identifier for the special effect resource. There is a one-to-one correspondence between the prop identifier and the special effect identifier. The terminal can obtain the special effect identifier of the target interactive prop by using a prop identifier of the target interactive prop. The special effect identifier may be provided by the terminal or a server. This is not limited in the embodiments of this application.

In some embodiments, the terminal stores the special effect identifier of the target interactive prop. The terminal can obtain the special effect identifier of the target interactive prop locally based on the prop identifier of the target interactive prop. In the solution provided in this embodiment of this application, the special effect identifier of the target interactive prop is obtained from the terminal, so that the special effect identifier can be quickly obtained, thereby improving efficiency of obtaining the special effect identifier, and further improving efficiency of human-computer interaction and efficiency of inter-account interaction.

In some embodiments, the terminal can further obtain the special effect identifier of the target interactive prop from the server. Correspondingly, a process in which the terminal obtains the special effect identifier is that the terminal transmits a prop use request to the server in response to the use operation on the target interactive prop; and then the terminal receives a special effect identifier that corresponds to the prop identifier and is returned by the server. The second account is an account represented by the target icon. The prop use request carries the first account, the second account, and the prop identifier of the target interactive prop. The server can determine the special effect identifier of the target interactive prop based on the prop identifier of the target interactive prop. In the solution provided in this embodiment of this application, the special effect identifier of the target interactive prop is obtained from the server, so that the special effect identifier can be accurately obtained, thereby improving accuracy of obtaining the special effect identifier. In addition, the terminal does not need to store the special effect resource and the special effect identifier of the interactive prop, thereby saving memory space.

A cheating tool may exist on a terminal side. By using the cheating tool, a quantity of interactive props of the first account may be increased on the terminal side, a type of the interactive prop of the first account may be modified, a special effect resource of the interactive prop of the first account may be modified, a new interactive prop not owned by the first account may be added to the first account, or the like. This is not limited in the embodiments of this application. However, the cheating tool cannot change data on a server side. Because the new interactive prop added by using the cheating tool does not belong to the first account, when the new interactive prop is used on the terminal side, a case in which an interactive prop not owned by the first account is used on another account occurs on the server side. This is apparently unreasonable and fairness of the virtual battle is lost. To maintain the fairness of the virtual battle, the server needs to perform verification on the prop use request, to perform verification on whether a to-be-used interactive prop is an interactive prop owned by the first account. If the verification is passed, it is determined that the to-be-used interactive prop is an interactive prop owned by the first account. In this case, the server returns the special effect identifier of the target interactive prop to the terminal, thereby avoiding the case in which the interactive prop not owned by the first account is used on another account, to ensure the fairness. Briefly, the special effect identifier is returned by the server when the prop use request satisfies a target condition. The target condition includes a plurality of conditions. A first condition is that a prop base of the first account includes the target interactive prop. A plurality of interactive props owned by the first account are stored in the prop base. The foregoing first condition can avoid using the interactive prop not owned by the first account on another account. A second condition is that the virtual battle has not started. The second condition can avoid displaying the prop selection area due to accidental touching of the icon when there is no need to use the interactive prop. A third condition is that prop cool down time is not shorter than a time threshold. The prop cool down time is configured for representing a time interval between two adjacent times of using the interactive prop by the first account. The third condition can limit a transmission frequency of the interactive prop, and avoid stuttering of the terminal due to frequent use of the interactive prop.

The following describes a process in which the server performs verification on the prop use request.

When the server receives the prop use request, the server obtains the first account and the prop identifier of the target interactive prop in the prop use request. Then, the server obtains, based on the first account, the interactive prop owned by the first account. Then, the server compares the prop identifier of the target interactive prop with a prop identifier of the interactive prop owned by the first account. When it is determined that the target interactive prop is not a prop owned by the first account, the server transmits prompt information to the terminal, to prompt that the first account cannot use the target interactive prop. When it is determined that the target interactive prop is a prop owned by the first account, the server determines, based on the first account and the second account in the prop use request, whether the virtual battle has started. When it is determined that the virtual battle has started, the server transmits prompt information to the terminal, to prompt that the first account cannot use the target interactive prop. When it is determined that the virtual battle has not started, the server determines that the first account can use an interactive prop for interaction. Then, the server obtains a historical usage moment of the last time the first account uses the interactive prop. Then, the server determines the prop cool down time based on the historical usage moment and a current moment. When the prop cool down time is shorter than the time threshold, the server transmits prompt information to the terminal, to prompt that the first account cannot use the target interactive prop. The server transmits the special effect identifier of the target interactive prop to the terminal when the prop cool down time is not shorter than the time threshold.

The terminal can perform verification before transmitting the prop use request to the server. A condition for the verification may be that the virtual battle has not started, or may be that the prop cool down time is not shorter than the time threshold. This is not limited in this application. The terminal can transmit the prop use request to the server after the verification is passed.

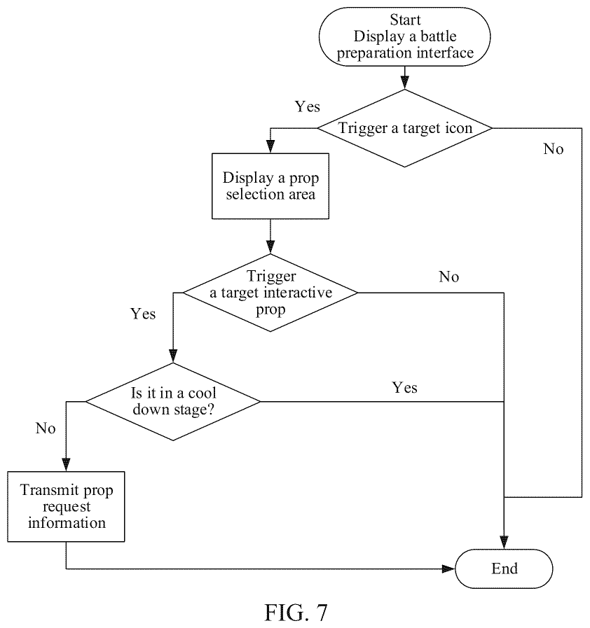

For example, FIG. 7 is a flowchart of transmitting a prop use request according to an embodiment of this application. Refer to FIG. 7. First, a terminal displays a battle preparation interface. Then, the terminal displays a prop selection area when a target icon is triggered. Then, any interactive prop is selected from the prop selection area as a target interactive prop to be used. The terminal can obtain prop cool down time when the target interactive prop is triggered. When the prop cool down time is not shorter than a time threshold, the terminal confirms that the prop is not in a prop cool down state currently. In other words, verification is passed. Then, the terminal can transmit the prop use request to a server. When the prop cool down time is shorter than the time threshold, the terminal confirms that the prop is currently in a cool down state, namely, a cool down (CD) time state. In other words, the verification is not passed. In this case, the terminal ends an operation of using the target interactive prop this time.

304: The terminal obtains the special effect resource of the target interactive prop based on the special effect identifier.

In this embodiment of this application, a special effect identifier of an interactive prop is configured for indicating a special effect resource of the interactive prop. Different interactive props have different special effect resources. The terminal can obtain the special effect resource of the target interactive prop based on the special effect identifier of the target interactive prop.

In some embodiments, the special effect resource includes three parts: a first special effect, a second special effect, and a third special effect respectively. The first special effect is a special effect presented by the target interactive prop at a location of the first icon. The second special effect is a special effect presented by the target interactive prop during movement. The third special effect is a special effect presented by the target interactive prop at a location of the target icon. The target interactive prop presents different special effects at different locations.

For example, the target interactive prop is a firework. When the firework is at the location of the first icon, the first special effect presented by the firework is an unignited firework. When the firework moves from the location of the first icon to a location of the second icon, the second special effect presented by the firework is that the firework has been ignited and gradually expands as the firework moves. When the firework reaches the location of the target icon, the third special effect presented by the firework is that the firework has exploded and sparks are splashed.

305: The terminal determines a special effect track of the special effect resource based on the location of the first icon and the location of the target icon.

In this embodiment of this application, the special effect track is a movement track of the special effect resource moving from the location of the first icon to the location of the target icon. The special effect track may be an irregular track, a straight line segment, a curved line segment, an arc segment, a sine line segment, a cosine line segment, or the like. This is not limited in the embodiments of this application. Display locations of the first icon and the target icon on the battle preparation interface may directly affect the movement track of the special effect resource. The terminal can obtain the location of the first icon and the location of the target icon based on the first icon and the target icon, to determine the special effect track of the special effect resource. Because display locations of the icons on the battle preparation interface at different preparation stages are different, and the locations of the first icon and the target icon are not unique, special effect tracks displayed on the battle preparation interface at different preparation stages are also different.

In a first case, at the team forming stage, for example, still refer to FIG. 4. 403 in FIG. 4 exemplarily shows a schematic diagram of a special effect track. A plurality of icons on the battle preparation interface are displayed in parallel in a horizontal direction. In other words, the first icon and the target icon are horizontally juxtaposed. In this case, the special effect track of the special effect resource is mostly a track in a horizontal direction, or a track in an approximate horizontal direction.

In a second case, at the object selection stage, for example, still refer to FIG. 5. 503 in FIG. 5 exemplarily shows a schematic diagram of a special effect track. A plurality of icons on the battle preparation interface include icons displayed horizontally in parallel, icons displayed vertically in parallel, and icons in other directions. In this case, the special effect track of the special effect resource may be a track in any direction. The special effect track shown in 503 in FIG. 5 is a special effect track in a form of a curved segment obliquely from lower left to upper right.

In a third case, at the loading stage, for example, still refer to FIG. 6. 603 in FIG. 6 exemplarily shows a schematic diagram of a special effect track. A plurality of icons on the battle preparation interface include icons displayed horizontally in parallel, icons displayed vertically in parallel, and icons in other directions. In this case, the special effect track of the special effect resource may be a track in any direction. The special effect track shown in 603 in FIG. 6 is a special effect track obliquely from upper right to lower left.

306: The terminal plays a target special effect animation based on the special effect resource and the special effect track, the target special effect animation being configured for presenting a special effect resource of the target interactive prop pointing from the first icon to the target icon.

In this embodiment of this application, the terminal moves the special effect resource according to the special effect track, and generates and plays the target special effect animation. The special effect resource sequentially presents the first special effect, the second special effect, and the third special effect during the movement.

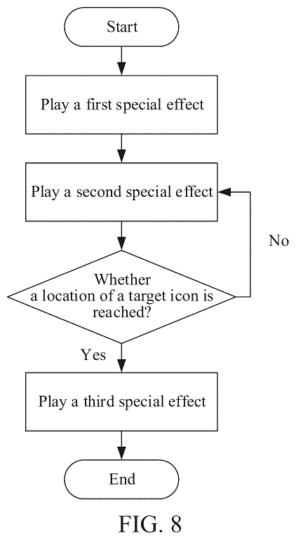

For example, FIG. 8 is a flowchart of playing a target special effect animation according to an embodiment of this application. Refer to FIG. 8. When a terminal has obtained a special effect resource of a target interactive prop and a special effect track, the terminal generates and plays a target special effect animation of the target interactive prop. In other words, the terminal first plays a first special effect in the special effect resource, and then plays a second special effect in the special effect resource. When the special effect resource does not reach a location of a target icon, the terminal continues to play the second special effect in the special effect resource. When the special effect resource reaches the location of the target icon, the terminal plays a third special effect in the special effect resource. When playing of the third special effect is completed, in other words, playing of the target special effect animation is completed, playing ends.

To more clearly show a change of a battle preparation interface when the target interactive prop is used, continuously refer to FIG. 4, FIG. 5, and FIG. 6. 401 to 403 in FIG. 4 exemplarily show an entire process in which the terminal displays the use of the target interactive prop on the battle preparation interface at the team forming stage. 501 to 503 in FIG. 5 exemplarily show an entire process in which the terminal displays transmission of the target interactive prop on the battle preparation interface at the object selection stage. 601 to 603 in FIG. 6 exemplarily show an entire process in which the terminal displays the transmission of the target interactive prop on the battle preparation interface at the loading stage. The entire process of displaying the use of the target interactive prop on the battle preparation interface is as follows: First, the first icon and the at least one second icon are displayed on the battle preparation interface. The player can long-press the target icon in the at least one second icon by using a finger. In this case, the terminal displays the prop selection area on the battle preparation interface. The prop selection area is a circular area, and a center of the prop selection area overlaps with a center of the target icon. The player drags, by using the finger, the target icon to the target interactive prop to be used. When the finger of the player is at a location of the target interactive prop, the player releases the finger and no longer drags the target icon. In this case, the terminal plays the target special effect animation of the target interactive prop.

To describe the solution more clearly, the following further provides overall description of the solution.

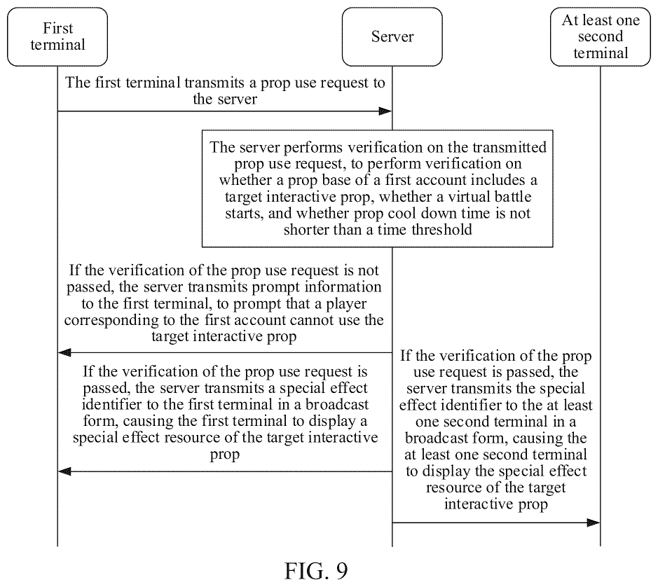

For example, FIG. 9 is an interaction flowchart of an inter-account interaction method according to an embodiment of this application. Refer to FIG. 9. A first terminal is a terminal on which a first account is logged in. At least one second terminal is a terminal on which an account other than the first account is logged in. The account is an account represented by a second icon on a battle preparation interface. The account include a second account represented by a target icon. In other words, the at least one second terminal includes a terminal on which the second account is logged in. When the first account uses a target interactive prop on the second account, the first terminal can transmit a prop use request to a server, the prop use request carrying the first account, the second account, and a prop identifier of the target interactive prop. The server can perform verification on the prop use request based on the first account and a target condition, to perform verification on whether a prop base of the first account includes the target interactive prop, whether a virtual battle starts, and whether prop cool down time is not shorter than a time threshold. When the prop base of the first account includes the target interactive prop, the virtual battle does not start, and the prop cool down time is not shorter than the time threshold, it is determined that the verification on the prop use request is passed. Then, the server can transmit a special effect identifier to the first terminal and the at least one second terminal in a broadcast form, so that both the first terminal and the at least one second terminal can display a special effect resource of the target interactive prop. If the verification on the prop use request is not passed, the server transmits prompt information to the first terminal, to prompt that a player corresponding to the first account cannot use the target interactive prop.

Through the solution provided in this embodiment of this application, the first account can also use an emoticon for another account, to be specific, the first account transfers an emoticon to another account, to perform interaction with another account. This is not limited in this application.

In the solution provided in this embodiment of this application, when preparing for the virtual battle, by triggering the target icon on the battle preparation interface, the prop selection area including at least one interactive prop can be displayed on the battle preparation interface. By selecting the target interactive prop in the at least one interactive prop, a target special effect animation corresponding to the target interactive prop can be played, and that the first account uses the target interactive prop on another account can be intuitively displayed. In this way, interaction between the first account and another account is implemented. To be specific, interaction can be performed without using a chat channel. This not only enriches an interaction manner, but also improves efficiency of human-computer interaction, and further improves efficiency of inter-account interaction.

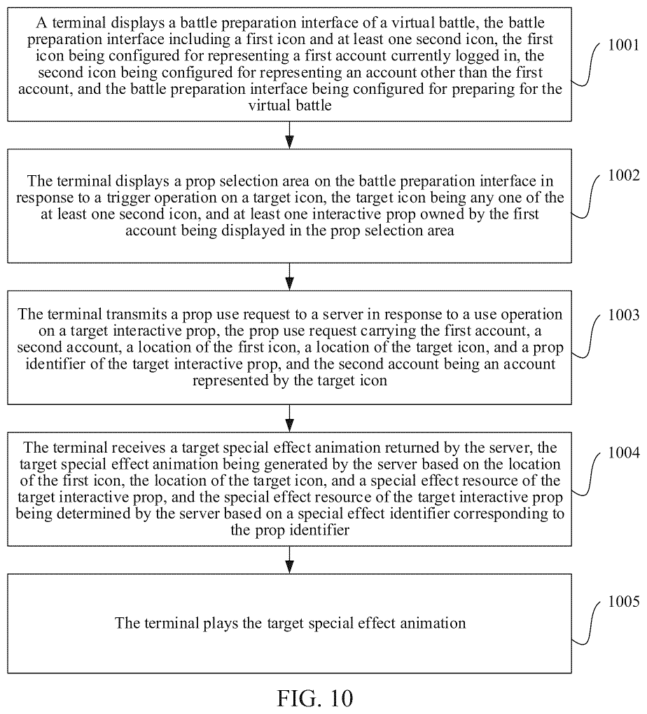

The terminal can directly obtain the target special effect animation of the target interactive prop from the server based on the solution provided in this embodiment of this application. The solution provided in this application is further described below by using an example in which the server generates the target special effect animation. FIG. 10 is a flowchart of another inter-account interaction method according to an embodiment of this application. Refer to FIG. 10. Description is made by using execution by a terminal as an example in this embodiment of this application. The inter-account interaction method includes the following operations.

1001: The terminal displays a battle preparation interface of a virtual battle, the battle preparation interface including a first icon and at least one second icon, the first icon being configured for representing a first account currently logged in, the second icon being configured for representing an account other than the first account, and the battle preparation interface being configured for preparing for the virtual battle.

In this embodiment of this application, the terminal is the terminal 101 shown in FIG. 1. The terminal has an application supporting the virtual battle installed and run thereon. The virtual battle includes a preparation stage and a progress stage. At the preparation stage of the virtual battle, the terminal can prepare for the virtual battle. At the progress stage of the virtual battle, virtual objects of different camps confront each other in a virtual scene. When preparing for the virtual battle, the terminal can display the battle preparation interface of the virtual battle. A plurality of icons are displayed on the battle preparation interface. The plurality of icons include the first icon and the at least one second icon. A manner of displaying the battle preparation interface in operation 1001 is similar to a manner of displaying the battle preparation interface in operation 301. Details are not described herein again.

1002: The terminal displays a prop selection area on the battle

preparation interface in response to a trigger operation on a target icon, the target icon being any one of the at least one second icon, and at least one interactive prop owned by the first account being displayed in the prop selection area.

In this embodiment of this application, the terminal can display the prop selection area when any icon other than the first icon on the battle preparation interface is triggered. The prop selection area includes at least one interactive prop. The interactive prop may be a prop, such as a firework, a heart, or a flower, configured for interaction. This is not limited in the embodiments of this application. A manner of displaying the prop selection area in operation 1002 is similar to a manner of displaying the prop selection area in operation 302. Details are not described herein again.

1003: The terminal transmits a prop use request to a server in response to a use operation on a target interactive prop, the prop use request carrying the first account, a second account, a location of the first icon, a location of the target icon, and a prop identifier of the target interactive prop, and the second account being an account represented by the target icon.

In this embodiment of this application, the terminal can transmit the prop use request to the server, to obtain a target special effect animation of the target interactive prop from the server. The location of the first icon and the location of the target icon that are carried by the prop use request are configured for the server to determine a special effect track of a special effect resource. The prop identifier carried by the prop use request is configured for the server to determine a special effect identifier corresponding to the prop identifier. A manner of transmitting the prop use request to the server in operation 1003 is similar to a manner of transmitting the prop use request to the server in operation 303. Details are not described herein again.

1004: The terminal receives the target special effect animation returned by the server, the target special effect animation being generated by the server based on the location of the first icon, the location of the target icon, and a special effect resource of the target interactive prop, the special effect resource of the target interactive prop being determined by the server based on the special effect identifier corresponding to the prop identifier.

In this embodiment of this application, the target special effect animation is generated by the server. A process in which the server generates the target special effect animation is that the server determines the special effect identifier of the target interactive prop based on the prop identifier of the target interactive prop; then, the server obtains the special effect resource of the target interactive prop based on the special effect identifier; then, the server determines the special effect track of the special effect resource based on the location of the first icon and the location of the target icon; and finally, the server generates the target special effect animation based on the special effect resource and the special effect track. The foregoing manner in which the server generates the target special effect animation is similar to a manner in which the terminal generates the target special effect animation in operation 303 to operation 306. Details are not described herein again.

The target special effect animation is returned by the server when the prop use request satisfies a target condition. In other words, the server can perform verification on the prop use request, and only transmit the target special effect animation to the terminal when the verification is passed. A manner in which the server performs verification on the prop use request is similar to a manner in which verification is performed on the prop use request in operation 303. Details are not described herein again.

1005: The terminal plays the target special effect animation.

In this embodiment of this application, the terminal directly plays the target special effect animation after receiving the target special effect animation. A manner of playing the target special effect animation in operation 1005 is similar to a manner of playing the target special effect animation in operation 306. Details are not described herein again.

In the solution provided in this embodiment of this application, when preparing for the virtual battle, by triggering the target icon on the battle preparation interface, the prop selection area including the at least one interactive prop can be displayed on the battle preparation interface. By selecting the target interactive prop in the at least one interactive prop, the target special effect animation corresponding to the target interactive prop can be played, and that the first account uses the target interactive prop on another account can be intuitively displayed. In this way, interaction between the first account and another account is implemented. To be specific, interaction can be performed without using a chat channel. This not only enriches an interaction manner, but also improves efficiency of human-computer interaction, and further improves efficiency of inter-account interaction.

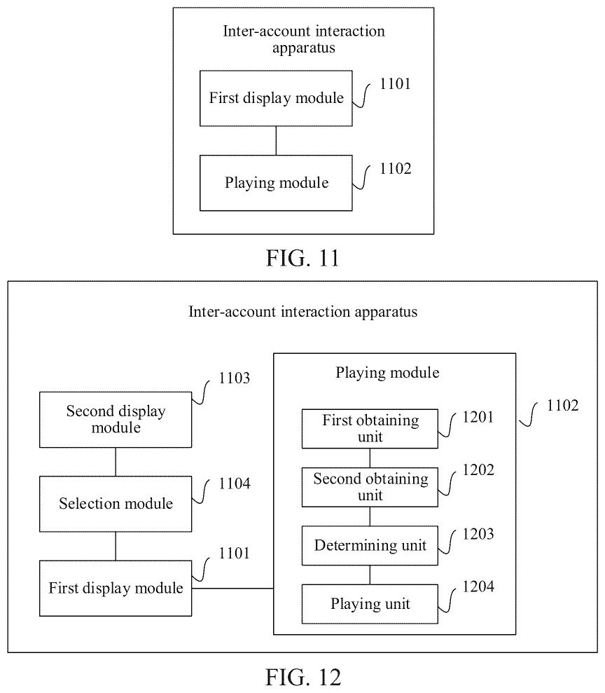

FIG. 11 is a schematic structural diagram of an inter-account interaction apparatus according to an embodiment of this application. The apparatus is configured to perform the operations of the foregoing inter-account interaction method. Refer to FIG. 11. The inter-account interaction apparatus includes: a first display module 1101 and a playing module 1102.

The first display module 1101 is configured to display a battle preparation interface of a virtual battle, the battle preparation interface including a first icon and at least one second icon, the first icon being configured for representing a first account currently logged in, the second icon being configured for representing an account other than the first account, and the battle preparation interface being configured for preparing for the virtual battle.

The first display module 1101 is further configured to display a prop selection area on the battle preparation interface in response to a trigger operation on a target icon, the target icon being any one of the at least one second icon, and at least one interactive prop owned by the first account being displayed in the prop selection area.

The playing module 1102 is configured to play a target special effect animation of a target interactive prop in response to a use operation on the target interactive prop, the target interactive prop being any one of the at least one interactive prop, and the target special effect animation being configured for presenting a special effect resource of the target interactive prop pointing from the first icon to the target icon.

In some embodiments, FIG. 12 is a schematic structural diagram of another inter-account interaction apparatus according to an embodiment of this application. Refer to FIG. 12. A playing module 1102 includes:
a first obtaining unit 1201, configured to obtain a special effect identifier of a target interactive prop in response to a use operation on the target interactive prop, the special effect identifier being configured for indicating a special effect resource of the target interactive prop;
a second obtaining unit 1202, configured to obtain the special effect resource of the target interactive prop based on the special effect identifier;
a determining unit 1203, configured to determine a special effect track of the special effect resource based on a location of a first icon and a location of a target icon; and
a playing unit 1204, configured to play a target special effect animation based on the special effect resource and the special effect track.

In some embodiments, still refer to FIG. 12. The first obtaining unit 1201 is configured to transmit a prop use request to a server in response to the use operation on the target interactive prop, the prop use request carrying a first account, a second account, and a prop identifier of the target interactive prop, and the second account being an account represented by the target icon; and receive a special effect identifier that corresponds to the prop identifier and is returned by the server.

In some embodiments, the special effect identifier is returned by the server when the prop use request satisfies a target condition; and
the target condition includes that
a prop base of the first account includes the target interactive prop, a plurality of interactive props owned by the first account being stored in the prop base;
a virtual battle has not started; and
prop cool down time is not shorter than a time threshold, the prop cool down time being configured for representing a time interval between two adjacent times of using the interactive prop by the first account.

In some embodiments, still refer to FIG. 12. The playing module 1102 is configured to transmit the prop use request to the server in response to the use operation on the target interactive prop, the prop use request carrying the first account, the second account, the location of the first icon, the location of the target icon, and the prop identifier of the target interactive prop, and the second account being the account represented by the target icon; receive the target special effect animation returned by the server, the target special effect animation being generated by the server based on the location of the first icon, the location of the target icon, and the special effect resource of the target interactive prop, and the special effect resource of the target interactive prop being determined by the server based on the special effect identifier corresponding to the prop identifier; and play the target special effect animation.

In some embodiments, the special effect resource includes a first special effect, a second special effect, and a third special effect, the first special effect being a special effect presented by the target interactive prop at the location of the first icon, the second special effect being a special effect presented by the target interactive prop during movement, and the third special effect being a special effect presented by the target interactive prop at the location of the target icon.

In some embodiments, still refer to FIG. 12. A first display module 1101 is configured to: obtain a consumption frequency of at least one interactive prop in response to a trigger operation on a target icon; and display a prop selection area on a battle preparation interface based on the consumption frequency of the at least one interactive prop, the at least one interactive prop being displayed in the prop selection area in descending order of the consumption frequency.

In some embodiments, still refer to FIG. 12. The first display module 1101 is configured to: obtain a remaining quantity of the at least one interactive prop in response to the trigger operation on the target icon; and display the prop selection area on the battle preparation interface based on the remaining quantity of the at least one interactive prop, the at least one interactive prop being displayed in the prop selection area in descending order of the remaining quantity.

In some embodiments, still refer to FIG. 12. The first display module 1101 is configured to: obtain an account relationship between the first account and the second account in response to the trigger operation on the target icon, the second account being the account represented by the target icon; and display at least one interactive prop corresponding to the account relationship in the prop selection area of the battle preparation interface.

In some embodiments, still refer to FIG. 12. The first display module 1101 is configured to: display a prop selection control in response to the trigger operation on the target icon, the prop selection control being configured to select an interactive prop to be used on the second account, the second account being the account represented by the target icon; and display the prop selection area on the battle preparation interface in response to a trigger operation on the prop selection control.

In some embodiments, the prop selection area is a circular area, and a center of the prop selection area overlaps with a center of the target icon.

In some embodiments, still refer to FIG. 12. The apparatus further includes:
a second display module 1103, configured to display a prop adding interface, the prop adding interface being configured for adding an interactive prop for the first account; and
the second display module 1103 being further configured to display a plurality of interactive props of the first account in response to a trigger operation on a prop adding control on the prop adding interface; and
a selection module 1104, configured to determine, in response to a prop selection operation, the at least one interactive prop selected from the plurality of interactive props.

In the inter-account interaction apparatus provided in this embodiment of this application, when preparing for the virtual battle, by triggering the target icon on the battle preparation interface, the prop selection area including the at least one interactive prop can be displayed on the battle preparation interface. By selecting the target interactive prop in the at least one interactive prop, the target special effect animation corresponding to the target interactive prop can be played, and that the first account uses the target interactive prop on another account can be intuitively displayed. In this way, interaction between the first account and another account is implemented. To be specific, interaction can be performed without using a chat channel. This not only enriches an interaction manner, but also improves efficiency of human-computer interaction, and further improves efficiency of inter-account interaction.

When the inter-account interaction apparatus provided in the foregoing embodiment runs an application, division of the foregoing functional modules is merely an example for description. During actual application, the foregoing functions may be allocated to and completed by different functional modules as needed, that is, the internal structure of the apparatus is divided into different functional modules, to complete all or some of the functions described above. In addition, the inter-account interaction apparatus provided in the foregoing embodiments and the inter-account interaction method embodiments belong to a same conception. For details of a specific implementation process, refer to the method embodiments. Details are not described herein again.

In the embodiments of this application, a computer device can be configured as a terminal or a server. When the computer device is configured as a terminal, the technical solutions provided in the embodiments of this application may be implemented by using the terminal as an execution entity. When the computer device is configured as a server, the technical solutions provided in the embodiments of this application may be implemented by using the server as an execution entity, or the technical solutions provided in the embodiments of this application may be implemented through interaction between the terminal and the server. This is not limited in the embodiments of this application.

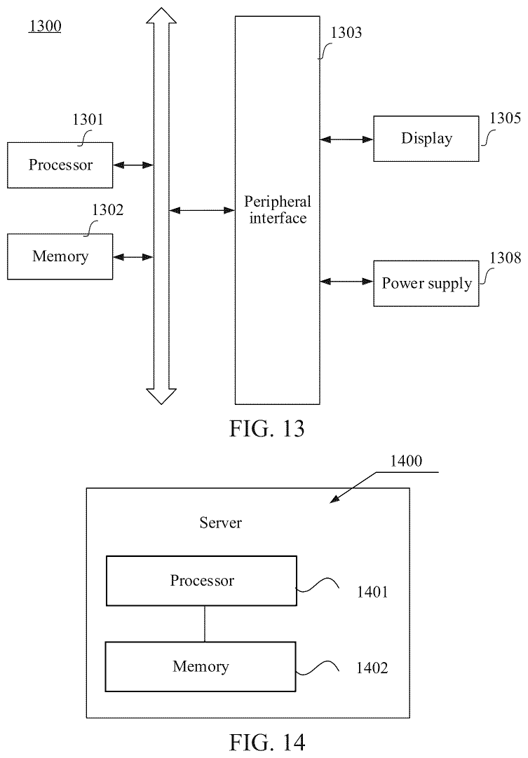

FIG. 13 is a schematic structural diagram of a terminal 1300 according to an embodiment of this application. The terminal 1300 may be a portable mobile terminal, for example, a smartphone, a tablet computer, a moving picture experts group audio layer III (MP3) player, a moving picture experts group audio layer IV (MP4) player, a notebook computer, or a desktop computer. The terminal 1300 may also be referred to as another name such as user equipment, a portable terminal, a laptop terminal, or a desktop terminal.

Generally, the terminal 1300 includes: a processor 1301 and a memory 1302.

The processor 1301 may include one or more processing cores, and may be, for example, a 4-core processor or an 8-core processor. The processor 1301 may be implemented in at least one hardware form of digital signal processing (DSP), a field-programmable gate array (FPGA), and a programmable logic array (PLA). The processor 1301 may alternatively include a main processor and a coprocessor. The main processor is configured to process data in an active state, and is also referred to as a central processing unit (CPU); and the coprocessor is a low-power processor configured to process data in a standby state. In some embodiments, the processor 1301 may have a graphics processing unit (GPU) integrated therein. The GPU is configured to render and draw content that needs to be displayed on a display. In some embodiments, the processor 1301 may further include an artificial Intelligence (AI) processor. The AI processor is configured to process a computing operation related to machine learning.

The memory 1302 may include one or more non-transitory computer-readable storage media that may be non-transitory. The memory 1302 may further include a high-speed random access memory and a non-volatile memory, for example, one or more disk storage devices or flash storage devices. In some embodiments, the non-transitory computer-readable storage medium in the memory 1302 is configured to store at least one computer program, the at least one computer program being configured to be executed by the processor 1301 to implement the inter-account interaction method provided in the method embodiments of this application.

In some embodiments, the terminal 1300 may exemplarily include: a peripheral interface 1303 and at least one peripheral. The processor 1301, the memory 1302, and the peripheral interface 1303 may be connected through a bus or a signal cable. Each peripheral may be connected to the peripheral interface 1303 through a bus, a signal cable, or a circuit board. Specifically, the peripheral includes: at least one of a display 1305 and a power supply 1308.

The peripheral interface 1303 may be configured to connect the at least one peripheral related to Input/Output (I/O) to the processor 1301 and the memory 1302. In some embodiments, the processor 1301, the memory 1302, and the peripheral interface 1303 are integrated on a same chip or a same circuit board. In some other embodiments, any one or two of the processor 1301, the memory 1302, and the peripheral interface 1303 may be implemented on an independent chip or circuit board. This is not limited in this embodiment.

The display 1305 is configured to display a user interface (UI). The UI may include a graphic, text, an icon, a video, and any combination thereof. When the display 1305 is a touch display, the display 1305 is further capable of collecting a touch signal on or above a surface of the display 1305. The touch signal may be inputted, as a control signal, to the processor 1301 for processing. In this case, the display 1305 may be further configured to provide a virtual button and/or a virtual keyboard that are/is also referred to as a soft button and/or a soft keyboard. In some embodiments, there may be one display 1305, disposed on a front panel of the terminal 1300. In some other embodiments, there may be at least two displays 1305, respectively disposed on different surfaces of the terminal 1300 or folded. In some other embodiments, the display 1305 may be a flexible display, disposed on a curved surface or a folded surface of the terminal 1300. The display 1305 may further be set to have a non-rectangular irregular graphic, namely, a special-shaped screen. The display 1305 may be prepared by using a material such as a liquid crystal display (LCD), an organic light-emitting diode (OLED), or the like.

The power supply 1308 is configured to supply power to components in the terminal 1300. The power supply 1308 may be an alternating-current power supply, a direct-current power supply, a disposable battery, or a rechargeable battery. When the power supply 1308 includes the rechargeable battery, the rechargeable battery may be a wired charging battery or a wireless charging battery. The wired charging battery is a battery charged through a wired line, and the wireless charging battery is a battery charged through a wireless coil. The rechargeable battery may further be configured to support a quick charge technology.

A person skilled in the art may understand that the structure shown in FIG. 13 constitutes no limitation on the terminal 1300, and the terminal may include more or fewer components than those shown in the figure, or some components may be combined, or a different component deployment may be used.

FIG. 14 is a schematic structural diagram of a server according to an embodiment of this application. A server 1400 may vary greatly due to different configurations or performance, and may include one or more processors (CPUs) 1401 and one or more memories 1402. The memory 1402 stores at least one computer program, the at least one computer program being loaded and executed by the processor 1401 to implement the inter-account interaction method provided in the foregoing method embodiments. Certainly, the server may further include components such as a wired or wireless network interface, a keyboard, and an input/output interface, to facilitate inputs/outputs. The server may further include another component configured to implement functions of a device. Details are not described herein again.

An embodiment of this application further provides a non-transitory computer-readable storage medium, the computer-readable storage medium having at least one computer program stored therein, the at least one computer program being loaded and executed by a processor of a computer device to implement the operations performed by the computer device in the inter-account interaction method in the foregoing embodiments. For example, the computer-readable storage medium may be a read-only memory (ROM), a random access memory (RAM), a compact disc read-only memory (CD-ROM), a magnetic tape, a floppy disk, an optical data storage device, or the like.

An embodiment of this application further provides a computer program product or a computer program, the computer program product or the computer program storing computer program code, the computer program code being stored in a computer-readable storage medium. A processor of a computer device reads the computer program code from the computer-readable storage medium, and executes the computer program code, causing the computer device to perform the inter-account interaction methods provided in the foregoing exemplary implementations.

A person of ordinary skill in the art may understand that all or part of the operations of implementing the foregoing embodiments may be implemented by hardware, or may be implemented by a program instructing related hardware. The program may be stored in a computer-readable storage medium. The foregoing storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. An inter-account interaction method performed by a computer device, the method comprising:
displaying a battle preparation interface of a virtual battle, the battle preparation interface comprising a first icon and at least one second icon, the first icon representing a first account associated with the computer device, the second icon representing an account other than the first account;
in response to a trigger operation on one of the at least one second icon as a target icon, displaying a prop selection area on the battle preparation interface and at least one interactive prop owned by the first account in the prop selection area; and
in response to a selection of one of the at least one interactive prop as a target interactive prop, playing a target special effect animation of transmitting a special effect resource of the target interactive prop pointing from the first icon to the target icon.

2. The method according to claim 1, wherein the playing a target special effect animation of transmitting a special effect resource of the target interactive prop pointing from the first icon to the target icon comprises:
obtaining a special effect identifier of the target interactive prop indicating the special effect resource of the target interactive prop;
obtaining the special effect resource of the target interactive prop based on the special effect identifier;
determining a special effect track of the special effect resource between a location of the first icon and a location of the target icon based on a type of the special effect resource; and
playing the target special effect animation based on the special effect resource and the special effect track.

3. The method according to claim 2, wherein the obtaining a special effect identifier of the target interactive prop comprises:
transmitting a prop use request to a server, the prop use request carrying the first account, a second account corresponding to the target icon, and a prop identifier of the target interactive prop; and
receiving a special effect identifier that corresponds to the prop identifier returned by the server.

4. The method according to claim 3, wherein the special effect identifier is returned by the server when the prop use request satisfies a target condition; and
the target condition being one selected from the group consisting of:
a prop base of the first account comprises the target interactive prop, a plurality of interactive props owned by the first account being stored in the prop base;
the virtual battle has not started; and
prop cool down time is not shorter than a time threshold, the prop cool down time being configured for representing a time interval between two adjacent times of using the interactive prop by the first account.

5. The method according to claim 1, wherein the playing a target special effect animation of transmitting a special effect resource of the target interactive prop pointing from the first icon to the target icon comprises:
transmitting a prop use request to a server, the prop use request carrying the first account, a second account corresponding to the target icon, a location of the first icon, a location of the target icon, and a prop identifier of the target interactive prop;
receiving the target special effect animation returned by the server, the target special effect animation being generated by the server based on the location of the first icon, the location of the target icon, and the special effect resource of the target interactive prop, and the special effect resource of the target interactive prop being determined by the server based on a special effect identifier corresponding to the prop identifier; and
playing the target special effect animation.

6. The method according to claim 1, wherein the special effect resource comprises a first special effect at a location of the first icon, a second special effect during movement of the target interactive prop, and a third special effect at a location of the target icon.

7. The method according to claim 1, wherein the displaying a prop selection area on the battle preparation interface comprises:
obtaining a consumption frequency of the at least one interactive prop; and
displaying the prop selection area on the battle preparation interface based on the consumption frequency of the at least one interactive prop, the at least one interactive prop being displayed in the prop selection area in descending order of the consumption frequency.

8. The method according to claim 1, wherein the displaying a prop selection area on the battle preparation interface comprises:
obtaining a remaining quantity of the at least one interactive prop; and
displaying the prop selection area on the battle preparation interface based on the remaining quantity of the at least one interactive prop, the at least one interactive prop being displayed in the prop selection area in descending order of the remaining quantity.

9. The method according to claim 1, wherein the displaying a prop selection area on the battle preparation interface comprises:
obtaining an account relationship between the first account and a second account corresponding to the target icon; and
displaying at least one interactive prop corresponding to the account relationship in the prop selection area of the battle preparation interface.

10. The method according to claim 1, wherein the displaying a prop selection area on the battle preparation interface comprises:
displaying a prop selection control configured to select an interactive prop to be used on a second account corresponding to the target icon; and
displaying the prop selection area on the battle preparation interface.

11. A computer device, comprising a processor and a memory, the memory being configured to store at least one computer program, the at least one computer program, when executed by the processor, causing the computer device to perform an inter-account interaction method including:
displaying a battle preparation interface of a virtual battle, the battle preparation interface comprising a first icon and at least one second icon, the first icon representing a first account associated with the computer device, the second icon representing an account other than the first account;
in response to a trigger operation on one of the at least one second icon as a target icon, displaying a prop selection area on the battle preparation interface and at least one interactive prop owned by the first account in the prop selection area; and
in response to a selection of one of the at least one interactive prop as a target interactive prop, playing a target special effect animation of transmitting a special effect resource of the target interactive prop pointing from the first icon to the target icon.

12. The computer device according to claim 11, wherein the playing a target special effect animation of transmitting a special effect resource of the target interactive prop pointing from the first icon to the target icon comprises:
obtaining a special effect identifier of the target interactive prop indicating the special effect resource of the target interactive prop;
obtaining the special effect resource of the target interactive prop based on the special effect identifier;
determining a special effect track of the special effect resource between a location of the first icon and a location of the target icon based on a type of the special effect resource; and
playing the target special effect animation based on the special effect resource and the special effect track.

13. The computer device according to claim 12, wherein the obtaining a special effect identifier of the target interactive prop comprises:
transmitting a prop use request to a server, the prop use request carrying the first account, a second account corresponding to the target icon, and a prop identifier of the target interactive prop; and
receiving a special effect identifier that corresponds to the prop identifier returned by the server.

14. The computer device according to claim 13, wherein the special effect identifier is returned by the server when the prop use request satisfies a target condition; and
the target condition being one selected from the group consisting of:
a prop base of the first account comprises the target interactive prop, a plurality of interactive props owned by the first account being stored in the prop base;
the virtual battle has not started; and
prop cool down time is not shorter than a time threshold, the prop cool down time being configured for representing a time interval between two adjacent times of using the interactive prop by the first account.

15. The computer device according to claim 11, wherein the playing a target special effect animation of transmitting a special effect resource of the target interactive prop pointing from the first icon to the target icon comprises:
transmitting a prop use request to a server, the prop use request carrying the first account, a second account corresponding to the target icon, a location of the first icon, a location of the target icon, and a prop identifier of the target interactive prop;
receiving the target special effect animation returned by the server, the target special effect animation being generated by the server based on the location of the first icon, the location of the target icon, and the special effect resource of the target interactive prop, and the special effect resource of the target interactive prop being determined by the server based on a special effect identifier corresponding to the prop identifier; and
playing the target special effect animation.

16. The computer device according to claim 11, wherein the special effect resource comprises a first special effect at a location of the first icon, a second special effect during movement of the target interactive prop, and a third special effect at a location of the target icon.

17. The computer device according to claim 11, wherein the displaying a prop selection area on the battle preparation interface comprises:
obtaining a consumption frequency of the at least one interactive prop; and
displaying the prop selection area on the battle preparation interface based on the consumption frequency of the at least one interactive prop, the at least one interactive prop being displayed in the prop selection area in descending order of the consumption frequency.

18. The computer device according to claim 11, wherein the displaying a prop selection area on the battle preparation interface comprises:
obtaining a remaining quantity of the at least one interactive prop; and
displaying the prop selection area on the battle preparation interface based on the remaining quantity of the at least one interactive prop, the at least one interactive prop being displayed in the prop selection area in descending order of the remaining quantity.

19. The computer device according to claim 11, wherein the displaying a prop selection area on the battle preparation interface comprises:
obtaining an account relationship between the first account and a second account corresponding to the target icon; and
displaying at least one interactive prop corresponding to the account relationship in the prop selection area of the battle preparation interface.

20. A non-transitory computer-readable storage medium storing at least one computer program therein, the at least one computer program, when executed by a processor of a computer, causing the computer device to perform an inter-account interaction method including:
displaying a battle preparation interface of a virtual battle, the battle preparation interface comprising a first icon and at least one second icon, the first icon representing a first account associated with the computer device, the second icon representing an account other than the first account;
in response to a trigger operation on one of the at least one second icon as a target icon, displaying a prop selection area on the battle preparation interface and at least one interactive prop owned by the first account in the prop selection area; and
in response to a selection of one of the at least one interactive prop as a target interactive prop, playing a target special effect animation of transmitting a special effect resource of the target interactive prop pointing from the first icon to the target icon.
